(19) United States
(12) Patent Application Publication
(10) Pub. No.: US 2026/0255316 A1
(43) Pub. Date: Aug. 27, 2026

(54) RADIO COMMUNICATION SYSTEM, CONTROL APPARATUS, MOVE DESTINATION POSITION DETERMINATION METHOD, AND PROGRAM

(71) Applicant: NIPPON TELEGRAPH AND TELEPHONE CORPORATION, Tokyo (JP)

(72) Inventors: Daisuke MURAYAMA, Tokyo (JP); Toshiro NAKAHIRA, Tokyo (JP); So TAKATANI, Tokyo (JP); Takeru FUKUSHIMA, Tokyo (JP)

(21) Appl. No.: 18/875,943

(22) PCT Filed: Jul. 4, 2022
(86) PCT No.: PCT/JP2022/026633

§ 371 Date: Dec. 17, 2024

(51) Int. Cl. H04W 64/00

(52) U.S. Cl. CPC H04W 64/006

(57) ABSTRACT

Provided is a wireless communication system including: one or more mobile wireless station devices that communicate with one or more terminal devices; and a control device, in which the control device calculates, on the basis of a position of each of the terminal devices, a plurality of movement destination position candidates of each of the mobile wireless station devices of which communication with the terminal device satisfies a required quality, and from among a plurality of the movement destination position candidates, selects, as a movement destination position for movement control, a movement destination position candidate having a minimum sum of movement costs for movement from a current position to a movement destination for the mobile wireless station device or a movement destination position candidate for which a maximum value of a movement cost for movement from the current position to the movement destination becomes minimum for one or more mobile wireless station devices.

### TECHNICAL FIELD

The present invention relates to a technology for controlling movement of a mobile wireless station device such as a movable base station device.

### BACKGROUND ART

Wireless communication technologies such as 5G and wireless LAN are widely used. In recent years, a technology for providing a natural communication environment in which a base station device is moved according to a degree of congestion with terminal devices or a change in a spatial environment and thus a user is not aware of a wireless network has been studied (for example, Non Patent Literature 1).

### CITATION LIST

### Non Patent Literature

### Non Patent Literature 1: The Institute of Electronics, Information and Communication Engineers (IEICE) 2021 General Conference B-5-131

### SUMMARY OF INVENTION

### Technical Problem

As described above, by moving the base station device, it is possible to effectively utilize wireless resources and provide an appropriate wireless communication service to the terminal device.

However, in a case where the distance (or time) required to move the base station device is long, there is a possibility that the communication quality in the terminal device deteriorates during the movement. Furthermore, power consumption required for the movement increases. Note that the target to be moved is not limited to the base station device. For example, the target to be moved may be a relay station device, an access point (AP), or the like. The target to be moved will be collectively referred to as a “mobile wireless station device”.

The present invention has been made in view of the above-described points, and an object of the present invention is to provide a technology for suppressing deterioration in quality of the communication during movement and suppressing an increase in power consumption for movement when movement control on the mobile wireless station device is performed.

### Solution to Problem

According to the disclosed technology, there is provided a wireless communication system including:
one or more mobile wireless station devices that communicate with one or more terminal devices; and
a control device,
in which the control device
calculates, on the basis of a position of each of the terminal devices, a plurality of movement destination position candidates of each of the mobile wireless station devices of which communication with the terminal device satisfies a required quality, and
from among a plurality of the movement destination position candidates, selects, as a movement destination position for movement control, a movement destination position candidate having a minimum sum of movement costs for movement from a current position to a movement destination for the mobile wireless station device or a movement destination position candidate for which a maximum value of a movement cost for movement from the current position to the movement destination becomes minimum for one or more mobile wireless station devices.

### Advantageous Effects of Invention

According to the disclosed technology, it is possible to suppress deterioration in quality of the communication during movement and suppress an increase in power consumption for movement when movement control on the mobile wireless station device is performed.

### BRIEF DESCRIPTION OF DRAWINGS

FIG. 1 is a diagram illustrating an overall configuration example of a system.

FIG. 2 is a diagram for explaining an outline of determination operation for a movement destination position by a control device 30.

FIG. 3 is a diagram illustrating a device configuration example.

FIG. 4 is a flowchart for explaining operation of the control device 30.

FIG. 5 is a diagram illustrating hierarchical clustering.

FIG. 6 is a diagram illustrating a hardware configuration example of a device.

### DESCRIPTION OF EMBODIMENTS

Hereinafter, an embodiment of the present invention (present embodiment) will be described with reference to the drawings. The embodiment to be described below is merely an example, and embodiments to which the present invention is applied are not limited to the following embodiment.

In the following description of the embodiment, a movable base station device is used as a mobile wireless station device to be moved, but this is an example. The base station device to be described below may be replaced with a relay station device, an AP, or a mobile wireless station device other than the relay station device and the AP.

Furthermore, the base station device may be a base station device in a cellular communication network (for example, 3G, 4G/LTE, 5G, and 6G), a base station device in a wireless LAN, or a base station device in a communication method other than these. Note that hereinafter, the base station device may be referred to as a “BS”.

### Overall Configuration Example of System

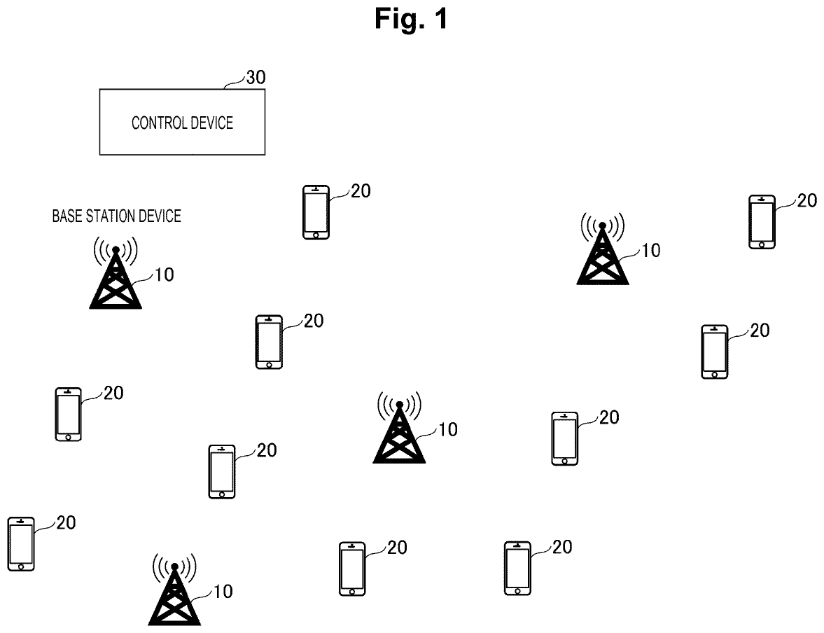

FIG. 1 illustrates an overall configuration example of a system according to the present embodiment. As illustrated in FIG. 1, in this system, there are a plurality of base station devices 10 and a plurality of terminal devices 20. Furthermore, there is a control device 30 that performs movement control on the base station devices 10. A system including one or more base station devices 10 and the control device 30 may be referred to as a wireless communication system.

Each of the base station devices 10 can move on the basis of control from the control device 30. The base station device 10 may be referred to as a movable base station device. Any means may be used for the movement. For example, the movement may be implemented by mounting the base station device 10 on a drone, the base station device 10 may be movable on a rail by being mounted on the rail, the movement may be implemented by mounting the base station device 10 on a vehicle, or the movement may be implemented by other methods. Here, the “base station device 10” also includes a movement means (drive unit).

Furthermore, in a case where the direction of an antenna included in the base station device 10 is variable, the control device 30 can change the direction of the antenna included in the base station device 10.

Each of the base station devices 10 can wirelessly communicate with each of the terminal devices 20. Furthermore, each base station device 10 can communicate with the control device 30 in a wired or wireless manner. The terminal device 20 can wirelessly communicate with one or a plurality of the base station devices 10.

### Outline of Determination Operation for Movement Destination Position by Control Device 30

As described above, in a case where the distance (or time) required to move the base station device 10 is long, there is a possibility that the communication quality in the terminal device 20 deteriorates during the movement. Furthermore, power consumption required for the movement increases.

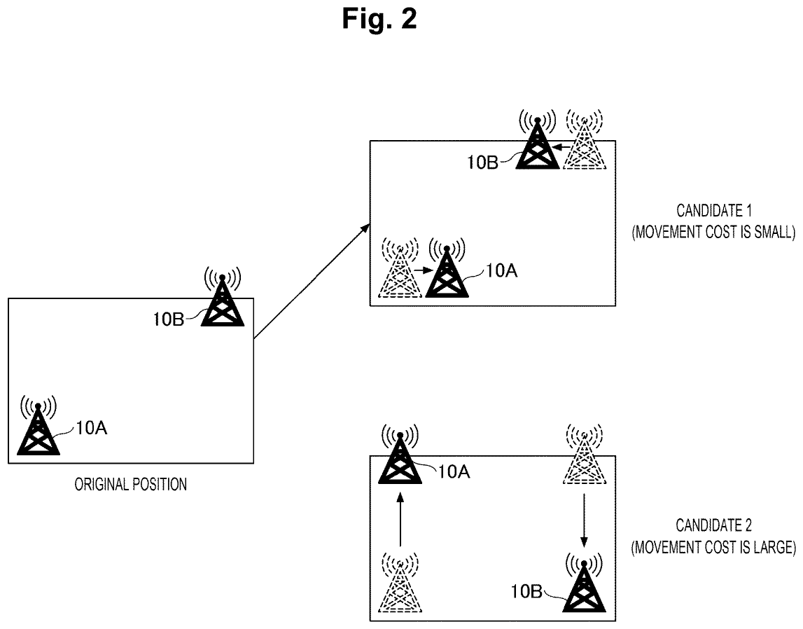

Therefore, in the present embodiment, the control device 30 determines the movement destination position of the base station device 10 in consideration of the movement cost of the base station device 10. An outline of a determination method for a movement destination position will be described with reference to FIG. 2.

First, the control device 30 predicts a position of each terminal device 20. In the present embodiment, the position of each terminal device 20 here may be a current position or a future position. In the present embodiment, the movement destination position of the base station device 10 suitable for the position of each terminal device 20 acquired here is determined.

For example, in a case where the environment of the present system is an environment such as a factory of which a layout is periodically changed, the control device 30 acquires planned layout change information in advance. In a case where the layout change information includes the position of each terminal device 20, the control device 30 can acquire the position of the terminal device 20 after the layout change from the layout change information.

Furthermore, the control device 30 may acquire the movement (future position) of the terminal device 20 (terminal device 20 held by a person) by a people flow simulation using machine learning or the like.

The control device 30 calculates the movement destination position candidate of each base station device 10 on the basis of the acquired position of each terminal device 20. Details of a calculation method will be described later. FIG. 2 illustrates an example. In the example of FIG. 2, the control device 30 calculates a movement destination position candidate of a route 1 and a movement destination position candidate of a route 2. The control device 30 selects a movement destination position candidate of the route 1 having a small movement cost from these two movement destination position candidates, and executes movement of each base station device 10 by using the movement destination position of the route 1.

### Device Configuration Example

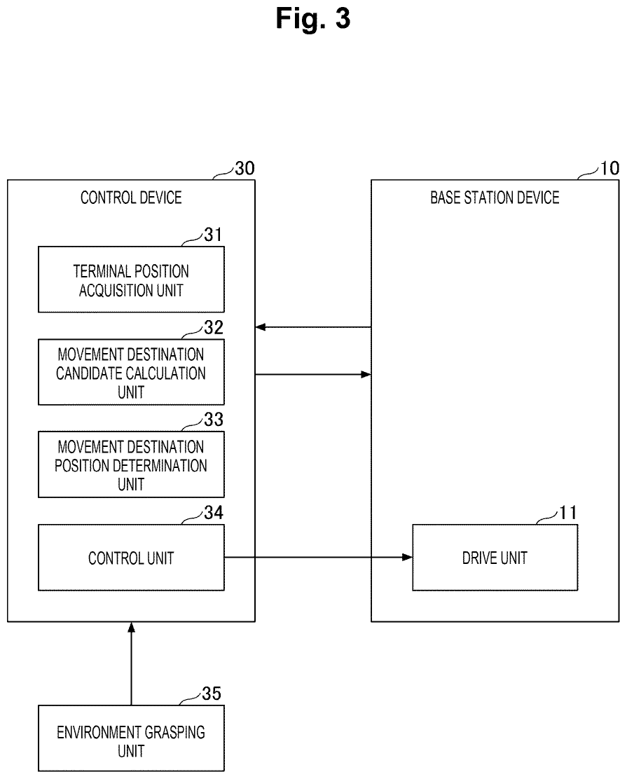

FIG. 3 illustrates a configuration example of devices constituting a wireless communication system according to the present embodiment. As illustrated in FIG. 3, this wireless communication system includes the control device 30 and the base station device 10. As described above, the base station device 10 is an example of a mobile wireless station device to be subjected to movement control. Although FIG. 3 illustrates one base station device 10, there are actually one or more base station devices 10.

The control device 30 and the base station device 10 are connected in a wired or wireless manner. Furthermore, as illustrated in FIG. 1, the base station device 10 can wirelessly communicate with the terminal device 20.

The base station device 10 includes a drive unit 11. The drive unit 11 moves the base station device 10 to a desired position in accordance with an instruction from a control unit 34 of the control device 30.

The control device 30 includes a terminal position acquisition unit 31, a movement destination candidate calculation unit 32, a movement destination position determination unit 33, and the control unit 34. Furthermore, in the example of FIG. 3, an environment grasping unit 35 (a camera, a sensor, and the like) is provided outside the control device 30.

The terminal position acquisition unit 31 predicts a position of each terminal device 20. For example, the terminal position acquisition unit 31 acquires the position of each terminal device 20 from information indicating the arrangement of each terminal device 20 acquired by the environment grasping unit 35.

The movement destination candidate calculation unit 32 calculates the movement destination position candidate of the base station device 10 on the basis of the position of each terminal device 20 acquired by the terminal position acquisition unit 31. The movement destination position determination unit 33 determines the movement destination position to be used for actual movement control from a plurality of the movement destination position candidates.

The control unit 34 performs control to move each base station device 10 to the movement destination position of each base station device 10 determined by the movement destination position determination unit 33. Note that the control unit 34 may be provided outside the control device 30.

### Operation Example

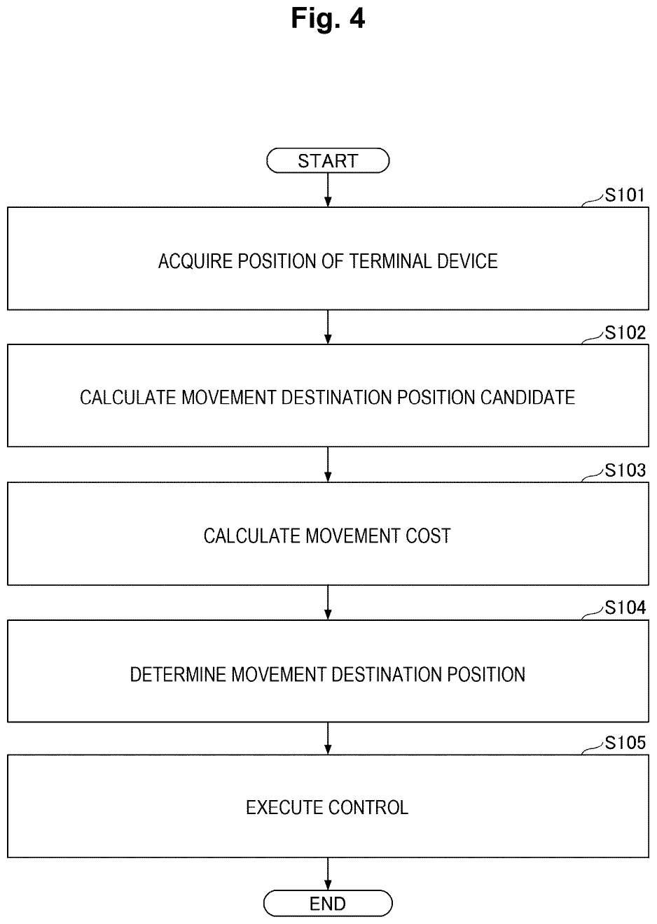

Next, the operation of the control device 30 will be described according to procedures of the flowchart of FIG. 4. In the operation to be described below, it is assumed that there is an area (referred to as a target area) which the control device 30 supports, and the terminal device 20 and the base station device 10 in the target area are control targets. Furthermore, one or a plurality of terminal devices 20 and one or a plurality of base station devices 10 are present in the target area.

### <S101>

In S101, the terminal position acquisition unit 31 acquires the position of each terminal device 20.

### <S102>

In S102, the movement destination candidate calculation unit 32 calculates a plurality of the movement destination position candidates of each base station device 10 on the basis of the position of the terminal obtained by the terminal position acquisition unit 31. A calculation method for a movement destination position candidate of each base station device 10 is not limited to a specific method, but for example, the following calculation method example 1 or calculation method example 2 can be used.

Note that in the following calculation method example 1 and calculation method example 2, it is assumed that the antenna of the base station device 10 is an omnidirectional antenna. In a case where the antenna of the base station device 10 is an antenna having directivity (in a case of an antenna of which the direction can be changed), for example, in the following calculation of a predicted communication quality, the predicted communication quality is only required to be calculated in a case where the antenna is directed in a direction in which the predicted communication quality is best.

### Calculation Method Example 1

The movement destination candidate calculation unit 32 first randomly changes a terminal clustering initial value for a plurality of terminal devices 20 in the target area, and performs terminal clustering by a k-means method. Specifically, for example, the terminal clustering initial values corresponding to the number of target base station devices 10 (denoted as M) are set, and a plurality of the terminal devices 20 are divided into M clusters. Such clustering is performed a plurality of times by randomly changing the terminal clustering initial value.

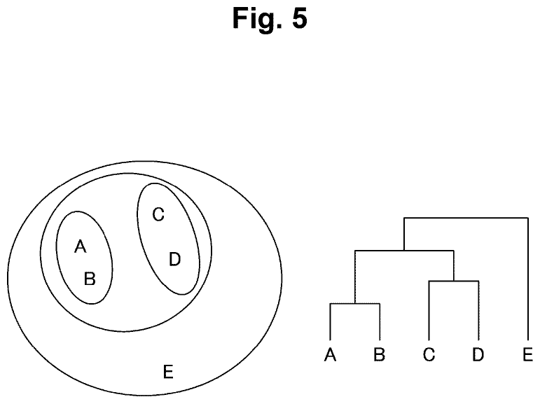

Note that the clustering may be performed using hierarchical clustering disclosed in Non Patent Literature 1. FIG. 5 illustrates an image of the hierarchical clustering in Non Patent Literature 1.

The movement destination candidate calculation unit 32 moves the base station device 10 (on a computer) to the barycentric position of each cluster, and obtains a position candidate where the predicted communication quality after the movement (predicted communication quality in the terminal device 20) is equal to or greater than a predetermined value. That is, the movement destination position candidate of each base station device 10 of which the communication with the terminal device 20 satisfies the required quality is calculated.

For example, it is assumed that there are BS1 and BS2 as target base station devices, and {(BS1, P11), (BS2, P21)} and {(BS1, P12), (BS2, P22)} are obtained as position candidates (Notation as (BS, P)) of BSs based on clustering performed twice with different initial values.

At this time, for example, when the predicted communication quality of only the {(BS1, P11), (BS2, P21)} of the two positions is equal to or greater than a predetermined value, {(BS1, P11), (BS2, P21)} becomes a position candidate.

The calculation method for the predicted communication quality is not limited to a specific method, but for example, a line-of-sight area rate, a predicted throughput integration value, or a required quality achievement terminal rate can be used.

The line-of-sight area rate is a rate of the area of an area where the terminal device 20 is present such that the base station device 10 can be seen from the terminal device 20 (that is, there is no obstacle between the terminal device 20 and the base station 10) in the area of the target area. For example, by dividing the target area into mesh areas, it is possible to obtain the area of the area where the terminal device 20 is present such that the base station device 10 can be seen from the terminal device 20.

As an example, in a case where BS1 and BS2 exist and the positions of BS1 and BS2 are P11 and P21, respectively, when the line-of-sight area rate with the terminal device 20 under the control of BS1 (in the cluster of BS1) is 30% and the line-of-sight area rate with the terminal device 20 under the control of BS2 (in the cluster of BS2) is 20%, the line-of-sight area rate for {(BS1, P11), (BS2, P21)} is 50%.

The predicted throughput integration value is a value obtained by integrating (summing) the predicted throughputs of the terminal device 20 for all the target terminal devices 20. The throughput can be estimated from reception power of a signal from the base station device 10 in the terminal device 20.

The required quality achievement terminal rate is a rate of the terminal devices 20 achieving the required quality among all the target terminal devices 20. The required quality is, for example, a throughput. Since the throughput can be estimated from the reception power as described above, it is possible to determine whether or not the required quality is achieved for each terminal device 20 by comparing the estimated throughput with the required quality.

Note that there is an effect that the calculation amount can be reduced by performing terminal clustering as in the calculation method example 1. In a case where the clustering is not performed, a path loss or the like between each base station device and all the terminal devices in the target area is calculated in all combinations of BS arrangements as described in the calculation method example 2, and the reception quality at a terminal point is obtained. Therefore, the calculation amount increases depending on conditions. On the other hand, by performing the terminal clustering, it is possible to obtain the BS arrangement while reducing the calculation amount by calculating the path loss between the terminal device included in each cluster and the corresponding base station device.

### Calculation Method Example 2

The movement destination candidate calculation unit 32 calculates the predicted communication quality for all candidates for a position where the base station device 10 can take, and obtains a position candidate for which the predicted communication quality is equal to or greater than a predetermined value. The example of the calculation method for the predicted communication quality is as described above.

For example, it is assumed that there are BS1 and BS2 as target base station devices, and {(BS1, P11), (BS2, P21)} and {(BS1, P12), (BS2, P22)} are obtained as all position candidates (Notation as (BS, P) ) taken by BSs.

At this time, for example, when the predicted communication quality of only the {(BS1, P11), (BS2, P21)} of the two positions (positions of BSs) is equal to or greater than a predetermined value, {(BS1, P11), (BS2, P21)} becomes a position candidate.

### <S103>

In S103, the movement destination position determination unit 33 calculates the movement cost of each base station device 10. The movement cost is not limited to a specific one, and is, for example, a movement distance from an original position (current position) to the movement destination position, power consumption required for movement from the original position (current position) to the movement destination position, or time required for movement from the original position (current position) to the movement destination position. The power consumption required for movement can be calculated by integrating the power consumption per unit movement distance obtained in advance with the movement distance. The time required for movement can be calculated by integrating the time per unit movement distance obtained in advance with the movement distance.

The description will be made by using a specific example. The position P of BS is denoted by (BS, P). As a result of S102, it is assumed that two candidates of a “candidate 1:{(BS1, P1A), (BS2, P2A)}” and a “candidate 2:{(BS1, P1B), (BS2, P2B)}” are obtained as the movement destination position candidates. Furthermore, the original position (that is, the current position) of BS is set to {(BS1, P1), (BS2, P2)}.

As the movement cost of each BS in the candidate 1, the movement destination position determination unit 33 calculates C1A as the movement cost for the movement from P1 to P1A for BS1, and calculates C2A as the movement cost for the movement from P2 to P2A for BS2.

Furthermore, as the movement cost of each BS in the candidate 2, the movement destination position determination unit 33 calculates C1B as the movement cost for the movement from P1 to P1B for BS1, and calculates C2B as the movement cost for the movement from P2 to P2B for BS2.

### <S104>

In S104, the movement destination position determination unit 33 determines the movement destination position of each base station device 10 on the basis of the movement cost calculated in S103. Specific examples of the movement destination position determination method include a determination method 1 and a determination method 2 below.

### Determination Method 1:

The movement destination position determination unit 33 obtains the sum of the movement costs of all the target base station devices 10 for each movement destination position candidate, and selects the movement destination position candidate having the smallest sum of the movement costs as a final movement destination position.

In the specific example described above, the movement destination position determination unit 33 calculates “C1A+C2A” as the sum of the movement costs in the candidate 1, and calculates “C1B+C2B” as the sum of the movement costs in the candidate 2.

When the movement destination position determination unit 33 determines that “(C1A+C2A)<(C1B+C2B)”, the movement cost of the candidate 1 is smaller than that of the candidate 2, and thus the candidate 1 is selected as the final movement destination position.

### Determination Method 2:

The movement destination position determination unit 33 obtains the maximum movement cost from among the movement costs of all the target base station devices 10 for each movement destination position candidate, and selects the movement destination position candidate having the maximum movement cost being the minimum as the final movement destination position.

In the specific example described above, it is assumed that C1A is larger in C1A and C2A which are the movement costs of two BSs in the candidate 1. Furthermore, it is assumed that C2B is larger in C1B and C2B which are the movement costs of two BSs in the candidate 2.

When the movement destination position determination unit 33 determines that “(C1A<C2B)”, the maximum movement cost of the candidate 1 is smaller than the maximum movement cost of the candidate 2, and thus the candidate 1 is selected as the final movement destination position.

### <S105>

In S105, the control unit 34 performs control to move each base station device 10 on the basis of the determination result in S104.

### Hardware Configuration Example

The control device 30 can be implemented by, for example, causing a computer to execute a program. This computer may be a physical computer, or may be a virtual machine on a cloud.

Specifically, the control device 30 can be implemented by executing a program corresponding to processing to be performed in the control device 30 by using hardware resources such as a CPU and a memory, which are installed in the computer. The above-described program can be stored and distributed by being recorded on a computer-readable recording medium (portable memory or the like). Furthermore, the program can also be provided via a network such as the Internet or an electronic mail.

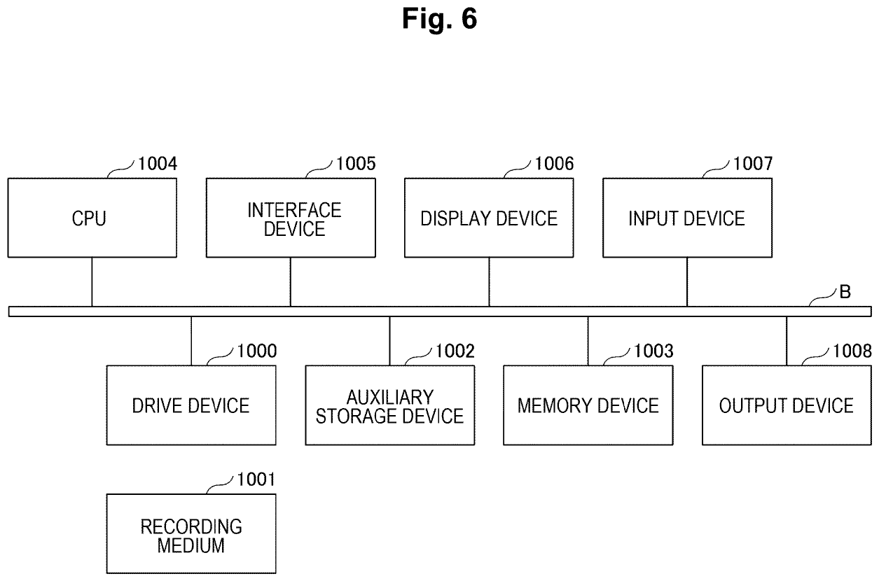

FIG. 6 is a diagram illustrating a hardware configuration example of the computer. The computer in FIG. 6 includes a drive device 1000, an auxiliary storage device 1002, a memory device 1003, a CPU 1004, an interface device 1005, a display device 1006, an input device 1007, and an output device 1008, which are connected to one another by a bus BS.

For example, a program for implementing processing in the computer is provided through a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

In a case where an instruction to start the program is given, the memory device 1003 reads the program from the auxiliary storage device 1002 and stores the program. The CPU 1004 implements a function related to the control device 30 in accordance with the program stored in the memory device 1003. Specifically, the CPU 1004 executes, for example, the procedure illustrated in FIG. 4.

The interface device 1005 is used as an interface for connection to a network or the like. The display device 1006 displays a graphical user interface (GUI) or the like according to the program. The input device 1007 is configured with a keyboard and a mouse, a button, a touch panel, or the like, and is used to input various operation instructions. The output device 1008 outputs a calculation result.

### Effects of Embodiments

As described above, in the technology according to the present embodiment, since the movement destination position is determined in consideration of the movement cost, it is possible to suppress deterioration in communication quality during movement and suppress an increase in power consumption for movement when performing movement control on the mobile wireless station device.

In the present embodiment, it is possible to suppress the quality deterioration and power consumption in the communication during movement particularly in a case where the mobile wireless station device moves sporadically.

Specifically, in the present embodiment, since the control for reducing the movement distance or the movement time is performed, it is possible to suppress the quality deterioration during the movement of the mobile wireless station device to be small. The present technology is suitable for a case of semi-static operation and low frequent movement.

Furthermore, Since Control Is Performed to reduce the power required for movement, it is possible to operate the system with low power consumption.

### Supplementary Notes

The present specification discloses at least a wireless communication system, a control device, a movement destination position determination method, and a program below.

### Supplementary Note 1

A wireless communication system including:
one or more mobile wireless station devices that communicate with one or more terminal devices; and
a control device,
in which the control device
calculates, on the basis of a position of each of the terminal devices, a plurality of movement destination position candidates of each of the mobile wireless station devices of which communication with the terminal device satisfies a required quality, and
from among a plurality of the movement destination position candidates, selects, as a movement destination position for movement control, a movement destination position candidate having a minimum sum of movement costs for movement from a current position to a movement destination for the mobile wireless station device or a movement destination position candidate for which a maximum value of a movement cost for movement from the current position to the movement destination becomes minimum for one or more mobile wireless station devices.

### Supplementary Note 2

The wireless communication system according to supplementary note 1,
in which the control device calculates the movement destination position candidate of each of the mobile wireless station devices by performing clustering on the terminal device.

### Supplementary Note 3

A control device in a wireless communication system including one or more mobile wireless station devices that communicate with one or more terminal devices, and the control device, the control device including:
a memory; and
at least one processor connected to the memory,
in which the processor
calculates, on the basis of a position of each of the terminal devices, a plurality of movement destination position candidates of each of the mobile wireless station devices of which communication with the terminal device satisfies a required quality, and
from among a plurality of the movement destination position candidates, selects, as a movement destination position for movement control, a movement destination position candidate having a minimum sum of movement costs for movement from a current position to a movement destination for the mobile wireless station device or a movement destination position candidate for which a maximum value of a movement cost for movement from the current position to the movement destination becomes minimum for one or more mobile wireless station devices.

### Supplementary Note 4

The control device according to supplementary note 3,
in which the processor calculates the movement destination position candidate of each of the mobile wireless station devices by performing clustering on the terminal device.

### Supplementary Note 5

A movement destination position determination method in a wireless communication system including one or more mobile wireless station devices that communicate with one or more terminal devices, and a control device, the method including:
by the control device, a step of calculating, on the basis of a position of each of the terminal devices, a plurality of movement destination position candidates of each of the mobile wireless station devices of which communication with the terminal device satisfies a required quality; and
by the control device, from among a plurality of the movement destination position candidates, a step of selecting, as a movement destination position for movement control, a movement destination position candidate having a minimum sum of movement costs for movement from a current position to a movement destination for the mobile wireless station device or a movement destination position candidate for which a maximum value of a movement cost for movement from the current position to the movement destination becomes minimum for one or more mobile wireless station devices.

### Supplementary Note 6

A non-transitory storage medium storing a program for causing a computer to function as each unit in the control device according to Supplementary note 3 or 4.

Although the present embodiments have been described above, the present invention is not limited to the specific embodiments, and various modifications and changes can be made within the scope of the gist of the present invention disclosed in the claims.

### REFERENCE SIGNS LIST

10 Base station device
11 Drive unit
20 Terminal device
30 Control device
31 Terminal position acquisition unit
32 Movement destination candidate calculation unit
33 Movement destination position determination unit
34 Control unit
35 Environment grasping unit
1000 Drive device
1001 Recording medium
1002 Auxiliary storage device
1003 Memory device
1004 CPU
1005 Interface device
1006 Display device
1007 Input device
1008 Output device

1. A wireless communication system comprising:
one or more mobile wireless station devices that communicate with one or more terminal devices; and
a control device,
wherein the control device
calculates, on a basis of a position of each of the terminal devices, a plurality of movement destination position candidates of each of the mobile wireless station devices of which communication with the terminal device satisfies a required quality, and
from among a plurality of the movement destination position candidates, selects, as a movement destination position for movement control, a movement destination position candidate having a minimum sum of movement costs for movement from a current position to a movement destination for the mobile wireless station device or a movement destination position candidate for which a maximum value of a movement cost for movement from the current position to the movement destination becomes minimum for one or more mobile wireless station devices.

2. The wireless communication system according to claim 1,
wherein the control device calculates the movement destination position candidate of each of the mobile wireless station devices by performing clustering on the terminal device.

3. A control device in a wireless communication system including one or more mobile wireless station devices that communicate with one or more terminal devices, and the control device, the control device comprising:
a processor; and
a memory storing program instructions that cause the processor to:
calculate, on a basis of a position of each of the terminal devices, a plurality of movement destination position candidates of each of the mobile wireless station devices of which communication with the terminal device satisfies a required quality; and
select, from among a plurality of the movement destination position candidates, as a movement destination position for movement control, a movement destination position candidate having a minimum sum of movement costs for movement from a current position to a movement destination for the mobile wireless station device or a movement destination position candidate for which a maximum value of a movement cost for movement from the current position to the movement destination becomes minimum for one or more mobile wireless station devices.

4. The control device according to claim 3,
wherein the program instructions cause the processor to calculate the movement destination position candidate of each of the mobile wireless station devices by performing clustering on the terminal device.

5. A movement destination position determination method in a wireless communication system including one or more mobile wireless station devices that communicate with one or more terminal devices, and a control device, the method comprising:
calculating, by the control device, on a basis of a position of each of the terminal devices, a plurality of movement destination position candidates of each of the mobile wireless station devices of which communication with the terminal device satisfies a required quality; and
from among a plurality of the movement destination position candidates, selecting, by the control device, as a movement destination position for movement control, a movement destination position candidate having a minimum sum of movement costs for movement from a current position to a movement destination for the mobile wireless station device or a movement destination position candidate for which a maximum value of a movement cost for movement from the current position to the movement destination becomes minimum for one or more mobile wireless station devices.

6. A non-transitory computer-readable recording medium having stored therein a program for causing a computer to perform the movement destination position determination method according to claim 5.
